(19) United States
(12) Patent Application Publication
(10) Pub. No.: US 2006/0221998 A1
(43) Pub. Date: Oct. 5, 2006

(54) Method and apparatus for performing dynamic link selection

(75) Inventors: Catherine Livet, Montreal (CA); Guang Lu, Montreal (CA); Maged Zaki, Pierrefonds (CA)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/311,207

(22) Filed: Dec. 19, 2005

Related U.S. Application Data
(60) Provisional application No. 60/667,173, filed on Mar. 31, 2005.

(51) Int. Cl. H04J 15/00

(52) U.S. Cl. 370/464

(57) ABSTRACT

A method and system for performing dynamic link selection (DLS) between transmit/receive units (TRUs). A first TRU determines whether a second TRU has multiple interfaces with a DLS capability. If the second TRU has multiple interfaces with the DLS capability, the first TRU sends a packet to the second TRU through a selected link. The first TRU then receives a report from the second TRU and evaluates quality of the link based on the report. The first TRU selects a link for a new packet in accordance with a predetermined criteria and the quality of the link. If the second TRU does not have multiple interfaces with the DLS capability, the first TRU periodically sends probe packets to the second TRU via all available links. The second TRU sends response packets and the first TRU evaluates the quality of link based on statistics of the response packets.

### CROSS REFERENCE TO RELATED APPLICATION

This application claims the benefit of U.S. provisional application No. 60/667,173 filed Mar. 31, 2005, which is incorporated by reference as if fully set forth.

### FIELD OF INVENTION

The present invention is related to communication systems. More particularly, the present invention is related to a method and apparatus for performing dynamic link selection (DLS) between transmit/receive units (TRUs).

### BACKGROUND

Currently, most TRUs have multiples interfaces to access networks, (e.g., the Internet), such that the TRUs may establish multiple links to the networks. The interfaces may be wired, (e.g., Ethernet, Fast Ethernet, Gigabit Ethernet, or the like), or wireless, (e.g., wireless fidelity (WiFi), IEEE 802.11b, 802.11a or 802.11g, 802.16, Bluetooth™ link, cellular link, or the like). Some TRUs may also include multiple interfaces using the same technologies. For example, a laptop computer may have an internal miniPCI and an external personal computer memory card international association (PCMCIA) WiFi connection.

During operation, one TRU may establish more than one link with another TRU where one link may have better performance in terms of throughput, delay, etc. than the other. In such case, it would be desirable to switch to the link having better performance.

### SUMMARY

The present invention is related to a method and apparatus for performing DLS between TRUs. A first TRU determines whether a second TRU has multiple interfaces with a DLS capability. If the second TRU has multiple interfaces with the DLS capability, the first TRU sends a packet to the second TRU through a selected link. The first TRU then receives a report from the second TRU and evaluates the quality of the link based on the report. The first TRU selects a link for a new packet in accordance with a predetermined criteria and the quality of the link. If the second TRU does not have multiple interfaces with the DLS capability, the first TRU periodically sends probe packets to the second TRU via all available links. The second TRU sends response packets in response to the probe packets and the first TRU evaluates the quality of link based on statistics of the response packets.

### BRIEF DESCRIPTION OF THE DRAWINGS

FIG. 1 shows an example of multiple connections between a TRU and a network wherein DLS is being performed in accordance with the present invention.

FIG. 2 shows a first TRU and a second TRU in a heterogeneous network while the transmitter implementing DLS in accordance with the present invention.

FIG. 3 shows transmission of periodic probe packets in accordance with the present invention.

FIG. 4 shows a first TRU and a second TRU implementing DLS in a homogeneous network in accordance with the present invention.

FIG. 5 is a flow diagram of a process for implementing DLS in accordance with the present invention.

### DETAILED DESCRIPTION OF THE PREFERRED EMBODIMENTS

Hereafter, the terminology “TRU” includes any wireless and wired communication unit including, but not limited to, a wireless transmit/receive unit (WTRU), a user equipment, a fixed or mobile station, a fixed or mobile subscriber unit, a pager, a laptop computer, a personal data assistance (PDA), or any other type of device capable of operating in a wireless or wired environment or both. When referred to hereafter, the terminology “base station” includes but is not limited to a Node-B, a site controller, an access point or any other type of interfacing device in a wireless environment.

The present invention is applicable to any wireless and wired communication system. For example, the present invention is applicable to an IEEE 802.21 system (media independent handover) for seamless mobility between a wired local area network (LAN), a wireless local area network (WLAN), a wireless metropolitan area network (WMAN) and a cellular network.

The features of the present invention may be incorporated into an integrated circuit (IC) or be configured in a circuit comprising a multitude of interconnecting components.

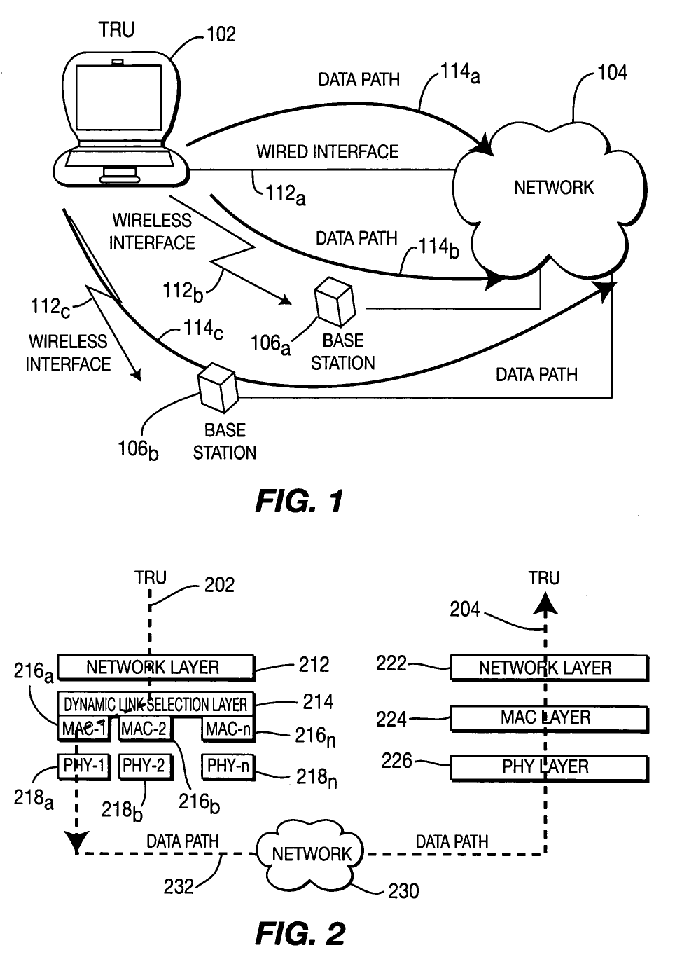

FIG. 1 shows an example of multiple connections between a TRU 102 and a network 104 wherein DLS is being performed in accordance with the present invention. The TRU 102 includes multiple interfaces 112a-112c. The interfaces 112a-112c may be a wired interface 112a, (such as Ethernet, fast Ethernet, gigabit Ethernet, or the like), or a wireless interface 112b, 112c, (such as WiFi, IEEE 802.11b, 802.11a or 802.11g, 802.16, Bluetooth™, cellular interface, or the like). The TRU 102 may establish multiple links 114a-114c, (i.e., multiple data paths), simultaneously. In the example of FIG. 1, the TRU 102 establishes three data paths to the network 104, (such as Internet protocol (IP) network), i.e., a wired link 114a to the network 104 using a wired interface 112a, a wireless link 114b via a base station 106a using a wireless interface 112b, and a wireless link 114c via a base station 106b using a wireless interface 112c.

In accordance with the present invention, the TRU 102 dynamically selects a link, (i.e., performs DLS), for data transmission in a transparent manner for the user. The purpose of DLS is to identify and utilize the best link to transmit data when multiples links are available between TRUs. The TRU 102 monitors each link and dynamically selects a link with the best performance in accordance with predetermined criteria. The criteria for performance evaluation include, but are not limited to, optimization of resources, a security, a quality of service (QoS), or the like.

FIG. 2 shows a first TRU 202 and a second TRU 204 in communication via a network 230 while only the first TRU 202 implements DLS in accordance with the present invention. It is up to the first TRU 202 to execute the DLS. The second TRU 204 may not have a DLS mechanism and therefore may not exchange information directly with the DLS of the first TRU 202.

The first TRU 202 comprises a network layer 212, a DLS layer 214, multiple medium access control (MAC) layers 216a-216n and corresponding physical (PHY) layers 218a-218n for supporting multiple interfaces under different communication protocols. The second TRU 204 comprises a network layer 222, a single MAC layer 224 and a single PHY layer 226. If the first TRU 202 implements DLS, the first TRU 202 selects a best link, (e.g., data link 232, through MAC 216a and PHY 218a), among the available links to connect to the network 230 and sends a data packet to the second TRU 204 through the selected link 232.

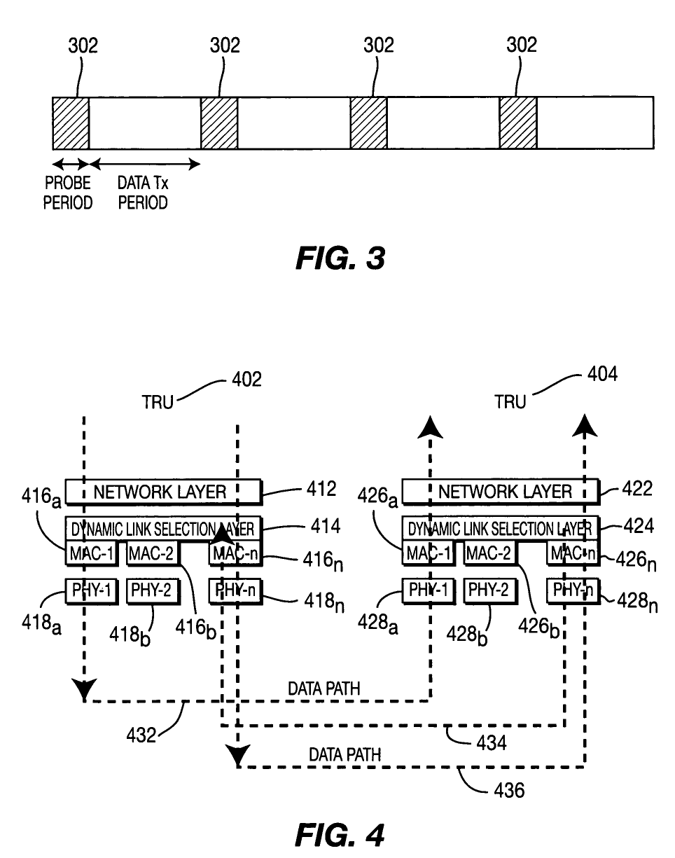

In order for the first TRU 202 to select the best link, a probe mechanism is used. FIG. 3 shows probe periods for transmitting probe packets. Periodic probe periods 302 are defined such that the DLS layer 214 of the first TRU 202 sends probe packets to the second TRU 204 every probe period 302 periodically via all possible links, (i.e., MACs 216a-216n and PHYs 218a-218n). The second TRU 204 receives the probe packets and sends a response packet to the first TRU 202. The first TRU 202 decides the best link between the first TRU 202 and the second TRU 204 based on statistics of the received response packets. The statistics includes, but is not limited to, at least one of a received signal strength indicator (RSSI), a signal-to-noise ratio (SNR), a bit error rate (BER), a frame error rate (FER) and delay of the response packets.

FIG. 4 shows a first TRU 402 in communication with a second TRU 404. The TRUs 402, 404 implement DLS in accordance with the present invention. In FIG. 4, both the first TRU 402 and the second TRU 404 have the DLS capabilities and a peer-to-peer communication mechanism may be established between the TRUs 402, 404. The first TRU 402 selects the best link based on feedback from the second TRU 404, which will be explained in detail hereinafter.

The first TRU 402 comprises a network layer 412, a DLS layer 414 and multiple MAC layers 416a-416n and corresponding PHY layers 418a-418n. The second TRU 404 comprises a network layer 422, a DLS layer 424 and multiple MAC layers 426a-426n and corresponding PHY layers 428a-428n. The DLS layer 414 of the first TRU 402 selects an interface, (e.g., a MAC layer 416a and a PHY layer 418a), and sends a data packet via a data path 432 which is received by the second TRU 404 by the PHY layer 428a and the MAC layer 426a. During data transmission over the selected link 432, a continuous monitoring of the other links occur via a peer-to-peer communication between the DLS layer 414 of the first TRU 402. If there is a link having a better quality than the currently selected link 432, the DLS layer 424 of the second TRU 404 sends a recommendation to the first TRU 402. For example, if at the second TRU 404, the link quality on the data path 432 that the second TRU perceived is poor, the DLS layer 424 of the second TRU 404 sends a peer-to-peer communication message 434 to the DLS layer 414 of the first TRU 402 informing that a MAC layer 416n and a PHY layer 418n are the recommended interface. The DLS layer 414 of the first TRU 402 may accept the recommendation and change the interface to the recommended one, (i.e., MAC/PHY layers 416n/418n), according to the feedback from the second TRU 404 and send a data packet to the second TRU 404 via a data path 436.

The DLS layer 414 of the first TRU 402 makes the final decision for the best link. The DLS layer 414 of the first TRU 402 may not accept the recommendation of the second TRU 404 and instead selects another interface and data path based on a priority, (e.g., quality of service (QoS)), on the first TRU 402 side. For example, the DLS layer 424 may recommend the MAC/PHY layers 416n/418n based on good CRC results of the received packets but without considering the data rate that the first TRU 402 uses to transmit on the link 436. If the data rate needed by the first TRU 402 to transmit is higher, (e.g. the first TRU 402 needs to transmit a 12 kbps voice call and the link 436 allows only to transmit at 6 kps), the DLS layer 414 of the first TRU 402 may select another link, (e.g. the link over MAC/PHY layers 416b/418b), which allows such transmission data rate as a new link.

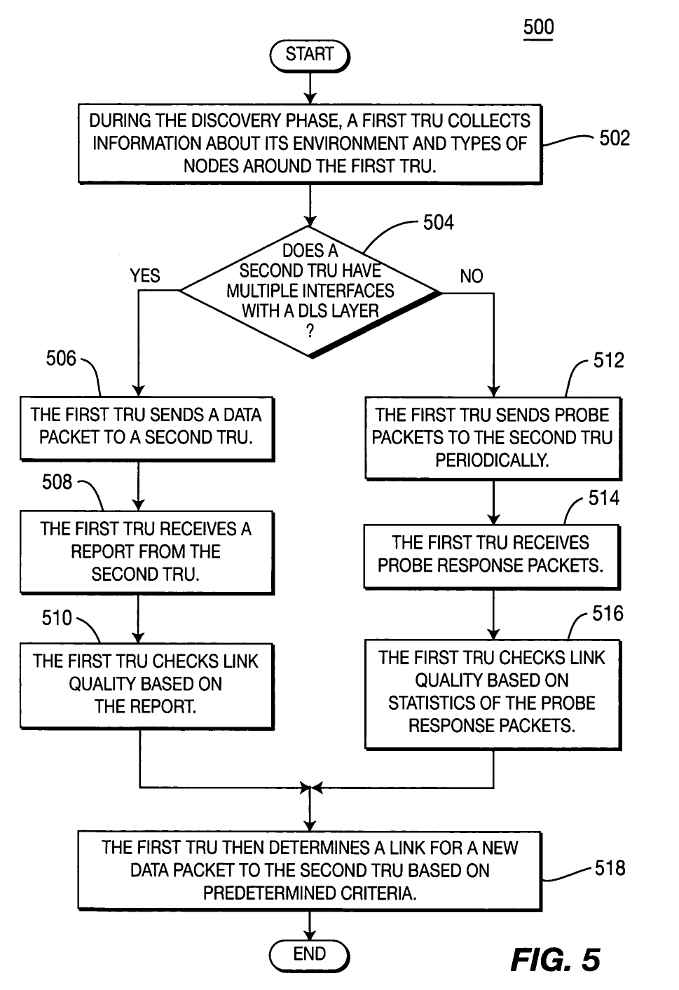

FIG. 5 is a flow diagram of a process 500 for implementing DLS in accordance with the present invention. During the discovery phase at step 502, a first TRU collects information about its environment and types of TRUs around the first TRU, (i.e., second TRUs). The information includes whether the second TRUs have multiple interfaces with a DLS layer, the kind of interface(s) the second TRUs have, (e.g., Ethernet, IEEE 802, cellular, Bluetooth™, or the like) and connection requirements, (i.e. which one is more important, QoS, resources saving, security, or the like).

For each of the second TRUs, the first TRU checks if each second TRU has multiple interfaces with a DLS layer or just one interface without a DLS layer (step 504). If the second TRU has multiple interfaces with a DLS layer, the first TRU starts sending data packets to the second TRU on a link and waits for a report from the second TRU (step 506). The first TRU receives a report from the second TRU (step 508). The report contains information about link quality of the link, such as a BER, a PER, a SNR, or the like. The first TRU checks the link quality based on the report (step 510).

If the second TRU has only one interface without a DLS layer, the first TRU sends probe packets periodically to the second TRU via all possible links (step 512). The first TRU receives probe response packets from the second TRU (step 514). The DLS layer of the first TRU checks a link quality based on statistics of the probe response packets, (e.g. BER, PER, SNR, or the like) (step 516).

The first TRU then selects a link for a new data packet to the second TRU based on predetermined criteria (step 518). The predetermined criteria includes, but is not limited to, at least one of QoS, link reliability, resources usage, cost and security. The first TRU may construct a metric for the determination that takes into account all or a portion of the above criteria.

For example, if the first TRU determines that the QoS or link reliability is not very critical for the next packet, the first TRU may select a link based on resource usage and chooses a link that consumes least resources. If the first TRU determines that the QoS or link reliability is very critical for the next packet, the first TRU may send the packets on more than one link to be combined at the second TRU to achieve maximum reliability.

Although the features and elements of the present invention are described in the preferred embodiments in particular combinations, each feature or element can be used alone without the other features and elements of the preferred embodiments or in various combinations with or without other features and elements of the present invention.

What is claimed is:

1. In a communication system including a first transmit/receive unit (TRU) and a second TRU, a method of selecting a link used to establish communications between the first TRU and the second TRU, the method comprising:
the first TRU determining whether the second TRU has multiple interfaces with a dynamic link selection (DLS) capability;
if the second TRU has multiple interfaces with the DLS capability, the first TRU sending a packet to the second TRU through a selected link over which the first TRU and the second TRU can communicate with each other and receiving a report from the second TRU; and
the first TRU selecting a link based on the report.

2. The method of claim 1 wherein the report from the second TRU includes link quality information.

3. The method of claim 2 wherein the link quality information includes at least one of a bit error rate, a packet error rate, a signal-to-noise ratio, a received signal strength indicator, throughput and delay time of the packet transmitted by the first TRU.

4. The method of claim 1 wherein the second TRU includes a recommended link in the report, whereby the first TRU may select the recommended link.

5. The method of claim 1 further comprising
if the second TRU does not have multiple interfaces with the DLS capability,
the first TRU periodically sending probe packets to the second TRU via all available links,
the second TRU sending response packets in response to the probe packets; and
the first TRU evaluating the quality of link based on statistics of the response packets.

6. The method of claim 5 wherein the statistics of the response packets includes at least one of a bit error rate, a packet error rate, a signal-to-noise ratio, a received signal strength indicator, throughput and delay time of the response packets.

7. The method of claim 1 wherein the predetermined criteria includes at least one of quality of service (QoS), resource availability, cost and security.

8. The method of claim 7 wherein the first TRU generates a combined metric for selecting a best link using the predetermined criteria.

9. The method of claim 7 further comprising the first TRU determining whether link reliability is critical for the new packet, whereby if the link reliability is not critical for the new packet, the first TRU chooses a link based on resource saving and if the link reliability is critical for the new packet, the first TRU chooses a link based on QoS.

10. A transmit/receive unit (TRU) for dynamically selecting a link, the TRU comprising:
multiple sets of physical layers and medium access control (MAC) layers, each set of physical layer and MAC layer supporting an interface under a different communication protocol; and
a dynamic link selection (DLS) layer configured to determine whether another TRU has multiple interfaces with a DLS capability, whereby if another TRU has multiple interfaces with the DLS capability, the DLS layer sends a packet to another TRU through a selected link and selects a link for a new packet based on a report which is sent by another TRU and a predetermined criteria.

11. The TRU of claim 10 wherein the report includes link quality information.

12. The TRU of claim 11 wherein the link quality information includes at least one of a bit error rate, a packet error rate, a signal-to-noise ratio, a received signal strength indicator and delay time of the packet.

13. The TRU of claim 10 wherein the DLS layer may accept a recommended link sent by another TRU in the report.

14. The TRU of claim 10 wherein if another TRU does not have multiple interfaces with the DLS capability, the DLS layer sends probe packets to another TRU via all available links and evaluates the quality of link based on statistics of response packets sent by another TRU in response to the probe packets.

15. The TRU of claim 14 wherein the statistics of the response packets includes at least one of a bit error rate, a packet error rate, a signal-to-noise ratio, a received signal strength indicator and delay time of the response packets.

16. The TRU of claim 10 wherein the predetermined criteria includes at least one of quality of service (QoS), resource availability, cost and security.

17. The TRU of claim 16 wherein the DLS layer generates a combined metric for selecting the link using the predetermined criteria.

18. The TRU of claim 16 wherein the DLS layer determines whether link reliability is critical for the new packet, whereby if the link reliability is not critical for the new packet, the DLS layer chooses a link based on resource saving and if the link reliability is critical for the new packet, the DLS layer chooses a link based on QoS.

19. A communication system supporting dynamic link selection, the system comprising:
a plurality of transmit/receive units (TRUs), at least one TRU comprising:
multiple sets of physical layers and medium access control (MAC) layers, each set of physical layer and MAC layer supporting an interface under a different communication protocol; and
a dynamic link selection (DLS) layer configured to determine whether another TRU has multiple interfaces with a DLS capability, whereby if another TRU has multiple interfaces with the DLS capability, the DLS layer sends a packet to another TRU through a selected link and selects a link for a new packet based on a report which is sent by another TRU and a predetermined criteria.

20. The system of claim 19 wherein the report includes link quality information.

21. The system of claim 20 wherein the link quality information includes at least one of a bit error rate, a packet error rate, a signal-to-noise ratio, a received signal strength indicator and delay time of the packet.

22. The system of claim 19 wherein the DLS layer of the TRU may accept a recommended link which is sent by another TRU in the report.

23. The system of claim 19 wherein if another TRU does not have multiple interfaces with the DLS capability, the DLS layer sends probe packets to another TRU via all available links and evaluates the quality of link based on statistics of response packets sent by another TRU in response to the probe packets.

24. The system of claim 23 wherein the statistics of the response packets includes at least one of a bit error rate, a packet error rate, a signal-to-noise ratio, a received signal strength indicator and delay time of the response packets.

25. The system of claim 19 wherein the predetermined criteria includes at least one of quality of service (QoS), resource availability, cost and security.

26. The system of claim 25 wherein the DLS layer generates a combined metric for selecting the link using the predetermined criteria.

27. The system of claim 25 wherein the DLS layer determines whether link reliability is critical for the new packet, whereby if the link reliability is not critical for the new packet, the DLS layer chooses a link based on resource saving and if the link reliability is critical for the new packet, the DLS layer chooses a link based on QoS.

28. An integrated circuit (IC) for selecting a link between transmit/receive units (TRUs) in communication, at least one link being established between the TRUs, the IC comprising:
multiple sets of physical layers and medium access control (MAC) layers, each set of physical layer and MAC layer supporting an interface under a different communication protocol;
a dynamic link selection (DLS) layer configured to determine whether another TRU has multiple interfaces with a DLS capability, whereby if another TRU has a DLS capability, the DLS layer sends a packet to another TRU through a selected link and selects a link for a new packet based a report from another TRU and a predetermined criteria.

29. The IC of claim 28 wherein the report from another TRU includes link quality information.

30. The IC of claim 29 wherein the link quality information includes at least one of a bit error rate, a packet error rate, a signal-to-noise ratio, a received signal strength indicator and delay time of the packet transmitted by the first TRU.

31. The IC of claim 28 wherein the DLS layer of the TRU may accept a recommended link sent by another TRU in the report.

32. The IC of claim 28 wherein if another TRU does not have multiple interfaces with the DLS capability, the DLS layer sends probe packets to another TRU via all available links and evaluates the quality of link based on statistics of response packets sent by another TRU in response to the probe packets.

33. The IC of claim 32 wherein the statistics of the response packets includes at least one of a bit error rate, a packet error rate, a signal-to-noise ratio, a received signal strength indicator and delay time of the response packets.

34. The IC of claim 28 wherein the predetermined criteria includes at least one of quality of service (QoS), resource availability, cost and security.

35. The IC of claim 34 wherein the DLS layer generates a combined metric for selecting the link using the predetermined criteria.

36. The IC of claim 34 wherein the DLS layer determines whether link reliability is critical for the new packet, whereby if link reliability is not critical for the new packet, the DLS layer chooses a link based on resource saving and if the link reliability is critical for the new packet, the DLS layer chooses a link based on QoS.
